(19) United States
(12) Patent Application Publication
(10) Pub. No.: US 2009/0199441 A1
(43) Pub. Date: Aug. 13, 2009

(54) High visibility ripper assembly and machine using same

(75) Inventors: John E. Jorgensen, E. Peoria, IL (US); Brian N. Madden, East Peoria, IL (US); Adam C. Grove, East Peoria, IL (US); William H. Zimmerman, Edelstein, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/069,540

(22) Filed: Feb. 11, 2008

(51) Int. Cl. A01B 63/102

(52) U.S. Cl. 37/455; 172/484

(57) ABSTRACT

A ripper assembly includes a beam assembly with a central ripper shank and tip flanked by a left linkage and a right linkage. In order to improve visibility of the central ripper shank and tip from an operator station of a track type tractor, the left linkage and the right linkage are unconnected to each other, except via the beam assembly. Without cross bracing between the left and right linkages, the beam assembly and individual linkages are configured to absorb side and twisting loads that may occur during production ripping. The ripper assembly left and right linkages may be of a fixed or variable parallelogram design. The hydraulic actuator(s) of the ripper assembly are configured to extend when moving to a dig position to provide a high penetration force. Part of the ripper assembly linkage shares a common pin with its associated hydraulic actuator. The ripper assembly may utilize a structurally efficient common pin shared between the beam assembly, lower link and hydraulic actuator on each side of the assembly.

### TECHNICAL FIELD

The present disclosure relates generally to ripper assemblies, and more particularly to a ripper assembly configured to provide line of sight visibility from an operator station of a track type tractor to a central ripper shank and tip.

### BACKGROUND

Production ripping has been used more and more today as an alternative to drilling and blasting with explosives. Current ripping strategies typically include mounting a ripper assembly with one or more ripper shanks on the back of a track type tractor or other machines known in the art. This arrangement, coupled with advanced hydraulic systems, more machine weight, and greater horsepower have greatly improved ripping performance and efficiency. A typical ripper assembly is based upon a parallelogram type linkage that may be lowered or raised to respective dig or raised stowed positions via one or more hydraulic actuators. In other ripper assemblies, an adjustable parallelogram permits adjusting an angle of attack of the ripper shank and tip via a second set of one or more hydraulic actuators. Most track type tractor manufacturers offer a ripper assembly, which may include one or more ripper shanks, as optional equipment that may be attached to a back of the tractor via conventional techniques, such as bolts.

Although a variety of ripper assemblies have performed well over many years, engineers are constantly seeking ways to improve ripper assemblies in a number of design and performance areas. For instance, when the ripper assembly is in a raised position, engineers are often seeking ways to increase a so called ground clearance ramp angle, which relates to how high the ripper tip(s) can be raised and pulled in close to a back of the tractor to avoid ground contact in the raised position. In addition, there continues to be efforts made to improve visibility of especially the central ripper shank and tip through as much as possible of the ripper assembly's range of motion, such as at penetration and during production ripping. This visibility factor is often compromised due to a need to cross brace the ripper assembly linkage to absorb side and twisting loads, especially in the case of multi-shank ripper assembly designs. Another performance parameter in constant need of improvement relates to the penetration force, the maximum penetration depth and the pry out force capabilities of a combined ripper assembly and track type tractor. Finally, there is sometimes a motivation to reduce the weight of the ripper assembly without compromising other performance variables. It has proven problematic and elusive to arrive at designs that effectively improve one or more characteristics of a ripper assembly without compromising others.

The present disclosure is directed to one or more of the problems set forth above and to other problems associated with improving ripper performance and design.

### SUMMARY OF THE DISCLOSURE

In one aspect, a ripper assembly includes a beam assembly with a central ripper shank and tip flanked by a left linkage and a right linkage. The left linkage includes an upper member extending between the beam assembly and an upper left tractor mount, a lower member extending between the beam assembly and a lower left tractor mount, and a left hydraulic actuator extending between the beam assembly and the upper left tractor mount. The right linkage includes an upper member extending between the beam assembly and an upper right tractor mount, a lower member extending between the beam assembly and a lower right tractor mount, and a right hydraulic actuator extending between the beam assembly and the upper right tractor mount. The left hydraulic actuator and the lower member of the left linkage are connected to the beam assembly via a left common pin. The right hydraulic actuator and the lower member of the right linkage are connected to the beam assembly via a right common pin.

In another aspect, a machine includes a ripper assembly attached to a back of a track type tractor that includes an operator station. The ripper assembly includes a beam assembly with a central ripper shank and tip flanked by a left linkage and a right linkage. At least one hydraulic actuator is included for moving the beam assembly between raised and dig positions. Each of the left linkage and right linkage include an upper member and a lower member extending between the beam assembly and the track type tractor. An initial penetration view of the central ripper tip is unobstructed by the ripper assembly from the operator station when the beam assembly is between the raised position and the dig position, and the central ripper tip is at a ground penetration level. A production ripping view of a portion of the central ripper shank above the ground penetration level is also unobstructed by the ripper assembly from the operator station when the beam assembly is at the dig position.

In still another aspect, a method of ripping includes moving a beam assembly of a ripper assembly from a raised position toward a dig position. The central ripper tip is observed along a line of sight extending from an operator station of a track type tractor to the central ripper tip when the central ripper tip is at a ground penetration level. The line of sight is unobstructed by the ripper assembly and extends between a left linkage and a right linkage of the ripper assembly. The portion of a central ripper shank above the ground penetration level is observed along a line of sight from the operator station to the central ripper shank that is unobstructed by the ripper assembly when the beam assembly is at the dig position. The line of sight extends between the left linkage and the right linkage of the ripper assembly.

### BRIEF DESCRIPTION OF THE DRAWINGS

FIG. 1 is a perspective view of a ripper assembly according to one aspect of the present disclosure;

FIG. 2 is a side view of a machine with a ripper assembly in a raised position;

FIG. 3 is a side view of the machine of FIG. 2, except showing the ripper assembly in a penetration position;

FIG. 4 is an initial penetration view of the central ripper tip of the ripper assembly along a line of sight from the operator station of the machine of FIGS. 2 and 3;

FIG. 5 is a side view of the machine of FIG. 2, except showing the ripper assembly in a dig position; and

FIG. 6 is a production ripping view similar to that of FIG. 4 except with the ripper assembly in a dig position as per FIG. 3.

### DETAILED DESCRIPTION

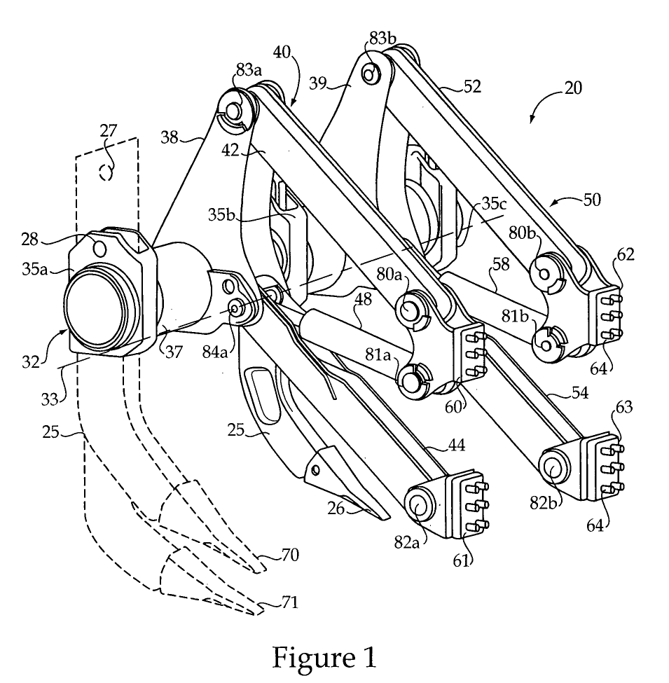

Referring to FIG. 1, a ripper assembly 20 includes a beam assembly 32 attached to a left linkage 40 and a right linkage 50. Left linkage 40 and right linkage 50 are illustrated as a fixed parallelogram, but the present disclosure also contemplates other ripper linkage configurations, including a variable parallelogram design and/or fixed or variable shapes that are other than a parallelogram. Left linkage 40 and right linkage 50 may be substantially identical to one another. Beam assembly 32 may include one or more elongate hollow cylinder beam members 37 shank mounts 35, and tower assemblies 38 and 39. Beam assembly 32 that is rotatable about a pin axis 33 when ripper assembly 20 is moved between raised and lowered positions. A central ripper shank 25 with a ripper tip 26 is attached to beam assembly at a centrally located shank mount 35b so as to be flanked by left linkage 40 and right linkage 50. Beam assembly 32 may include one or more a shank mounts 35 as is conventional in the art. In the illustrated embodiment, beam assembly 32 includes a left shank mount 35a, a central shank mount 35b and a right shank mount 35c. Shank mounts 35a and 35c may be outboard from left linkage 40 and right linkage 50, respectively.

In typical operation, the ripper assembly 20 may be equipped with either a single ripper shank 25 as shown, three ripper shanks, or only with left and right ripper shanks. Although not necessary, the ripper shanks 25 for the illustrated embodiment are configured to pin to the respective ripper shank mount 35 at either a shallow rip configuration 70 or a deep rip configuration 71 as shown in shadow with regard to the left shank mount 35a. In particular, at the shallow rip configuration 70, pin hole 28 is utilized, whereas pin hole 27 is utilized in the deep rip configuration 71. Those skilled in the art will appreciate the adaptability that additional depth ripping capabilities could be provided by including additional pin holes on ripper shanks 25 and/or providing different length ripper shanks shaped to accommodate shank mounts 35.

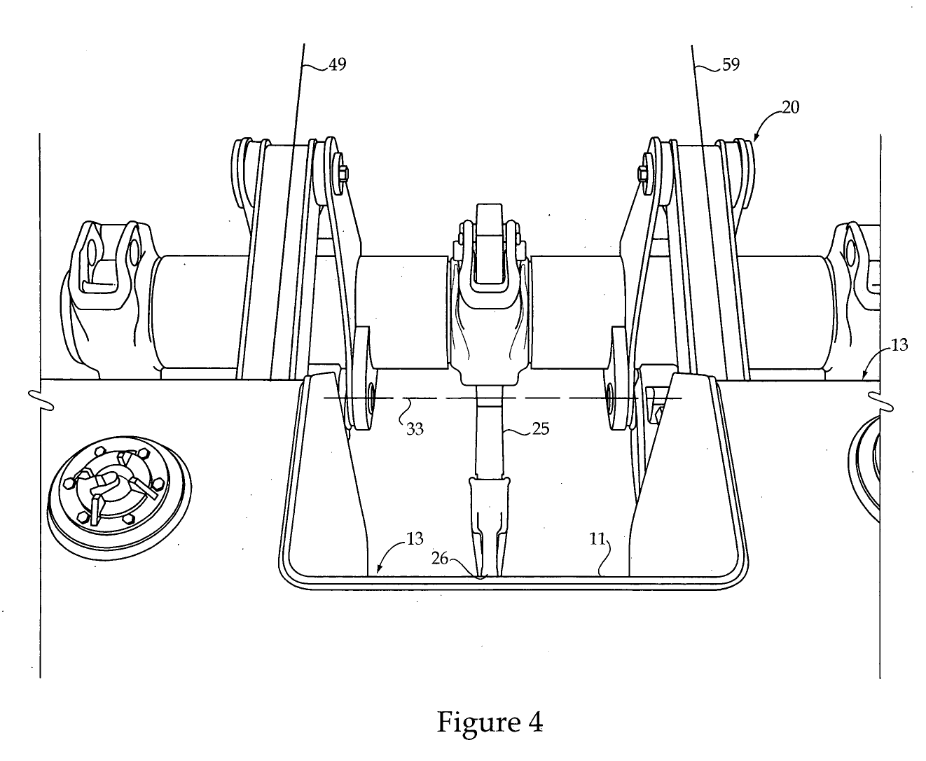

Beam assembly 32 includes a left tower 38 and a right tower 39 that may facilitate a pin connection to left linkage 40 and right linkage 50. In particular, left linkage 40 includes an upper member 42 connected to left tower 38 via a pin 83a, and an opposite end connected to an upper left tractor mount 60 via a pin 80a. Left linkage 40 also includes a lower member 44 connected to a lower portion of left tower 38 via a common pin 84a, and an opposite end connected to a lower left tractor mount 61 via a pin 82a. Finally, left linkage 40 includes a left hydraulic actuator 48 connected to left tower 38 via shared common pin 84a and connected at its opposite end to upper left tractor mount 60 via a pin 81a. In this configuration, all of the upper member 42, lower member 44 and left hydraulic cylinder 48 are intersected along their entire lengths via a left plane 49 (FIG. 4) that is perpendicular to axis 33 of beam assembly 32. Right linkage 50 is substantially identical to left linkage 40 in that it includes an upper member 52 connected to a top of right tower 39 via a pin 83b and connected at its opposite end to an upper right tractor mount 62 via a pin 80b. In addition, right linkage 50 includes a lower member 54 connected to a lower portion of tower 39 via a common pin not visible in FIG. 1, and connected at its opposite end to a lower right tractor mount 63 via a pin 82b. Finally, right linkage 50 includes a right hydraulic actuator 58 connected at one end to the same common pin that facilitates connection of lower member 54 to tower 39, and connected at its opposite end to upper right tractor mount 62 via a pin 81b. The various tractor mounts 60, 61, 62 and 63 may be attached to a back 13 of a machine 11, such a track type tractor via a conventional manner, such as a suitable array of fastener bolts 64. In particular, each of the tractor mounts in the illustrated embodiment are attached via six separate fasteners 64. As with the left linkage 40, the various components of a right linkage 50 (upper member 52, lower member 54, and right hydraulic actuator 58) are intersected along their entire lengths via a right plane 59 (FIG. 4) that is perpendicular to axis 33 and parallel to the left plane associated with left linkage 40 discussed earlier.

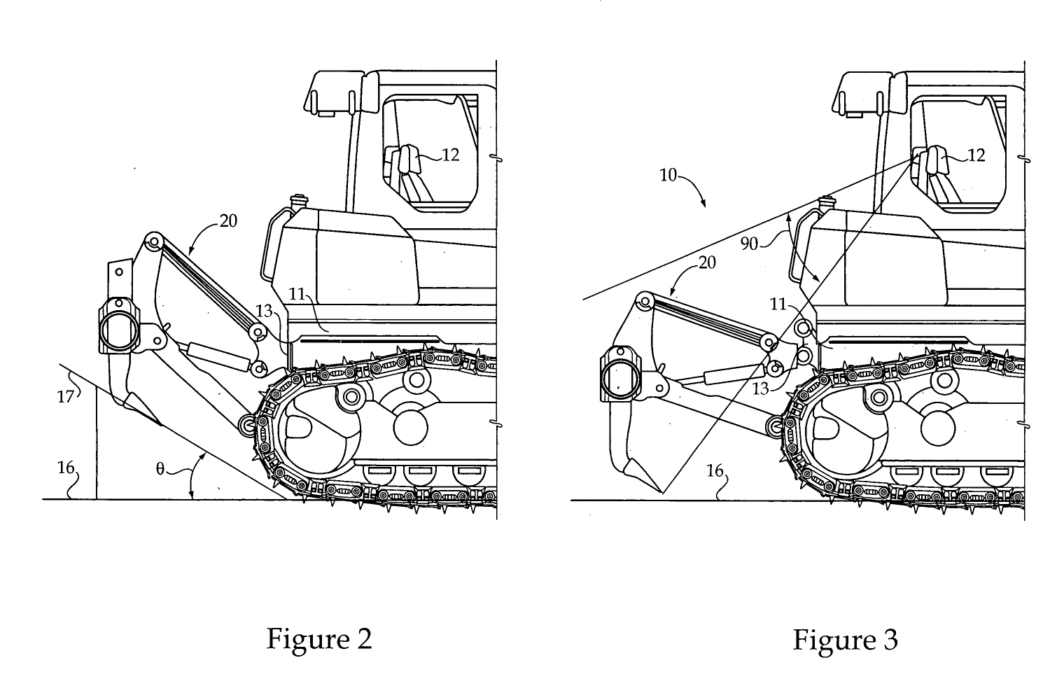

Although upper members 42 and 52 are shown as having a fixed non-extendable length, the present disclosure also contemplates variable length upper members to facilitate adjusting an angle of attack of the ripper shank when ripping in a manner well known in the art. In addition, upper members 42, 52 and lower members 44, 54 may be close in length so that linkage 40, 50 defines a so called fixed parallelogram when attached to a back 13 of a track type tractor 11. In particular, FIG. 2 shows ripper assembly 20 combined with track type tractor 11 to constitute a machine 10.

By utilizing the described structure, the ripper assembly 20 may be elevated to a raised position (see FIG. 2) such that a tangent line 17 that runs tangent to both the bottom of the ripper assembly 20 and the track type tractor 11 forms a ground clearance angle θ with regard to a ground penetration level 16. In the illustrated embodiment, the ground clearance angle θ may be about 30°. The term “about” as used in this disclosure, means that when the number is rounded to the same number of significant digits, the two numbers are equal. Thus, both 26 and 34 can be considered to be about 30.

The ripper assembly 20 of the present disclosure includes several subtle but important innovations that improve performance and visibility. Among these are the use of a common pin 84 for joining lower member 44, 54 and hydraulic actuators 48, 58 to the bottom of towers 38, 39 of beam assembly 32. In addition, by increasing stiffness of the beam assembly 32 in part via a hollow cylindrical tube 37 and by utilizing individual links 42, 44, 52 and 54, cross bracing that often appears in prior art ripper assemblies can be eliminated between lower member 44 and 54. Thus, with this construction, twisting and side loads on ripper assembly 20 are primarily absorbed by the beam assembly 32 and individual links 42, 44, 52 and 59, rather than in some cross-braced linkages as in the prior art. This allows for a drastic reduction in weight, and a shift of much of the overall weight of the ripper assembly 20 from the linkages 40, 50 to the beam assembly 32. In other words, previous ripper assemblies often include cross bracing between the lower members 44, 54 in order to absorb side and twisting loads which greatly increases the weight of the lower linkage relative to the beam assembly. In this case, the combined lower linkage mass, namely the combined mass of lower member 44 and lower member 54, is only about 30% of the beam mass of the beam assembly. The beam mass of the beam assembly is considered its mass without any attached ripper shanks. Even though the illustrated embodiment shows a beam assembly 32 including an elongate hollow cylinder 37 with a circular cross section, other shapes would fall within the scope of the present disclosure, including but not limited to rectangular and oblong shapes. The construction of the beam assembly of the illustrated embodiment allows for an improvement in the ability of ripper assembly to absorb side and twist loads while reducing the overall weight of the ripper assembly, especially as it relates to the lower linkage. Although the illustrated embodiment is shown as including no cross bracing between lower members 44 and 54, the present disclosure does not rule out all cross bracing in all embodiments provided that other features are maintained. Thus, in the illustrated embodiment, the left linkage 40 and right linkage 50 are unconnected to each other except via the beam assembly 32 when the ripper assembly is disconnected from a track type tractor 11, as illustrated in FIG. 1.

Referring now to FIGS. 3 and 4, an initial penetration view of the central ripper tip 26 along a line of sight from the operator station 12 of track type tractor 11 when the ripper assembly 20 is between a raised position and a dig position, and ripper tip 26 is at the ground penetration level 16. Thus, the operator can see the entire central ripper shank 25 and most, if not all, of ripper tip 26 without obstruction from other parts of ripper assembly 20, and maybe also from any portion of the back 13 of track type tractor 11, along a line of sight within a viewing cone 90 from the operator station 12 just as the end of ripper tip 26 is penetrating the ground 16. This gives the operator better direct visual feedback when initiating a ripping operation.

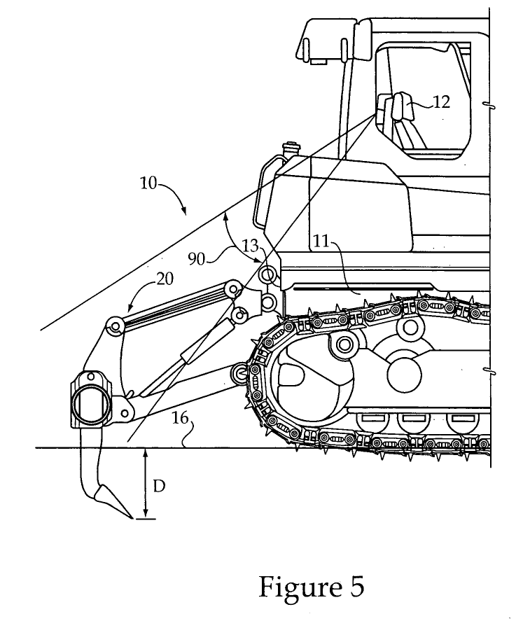

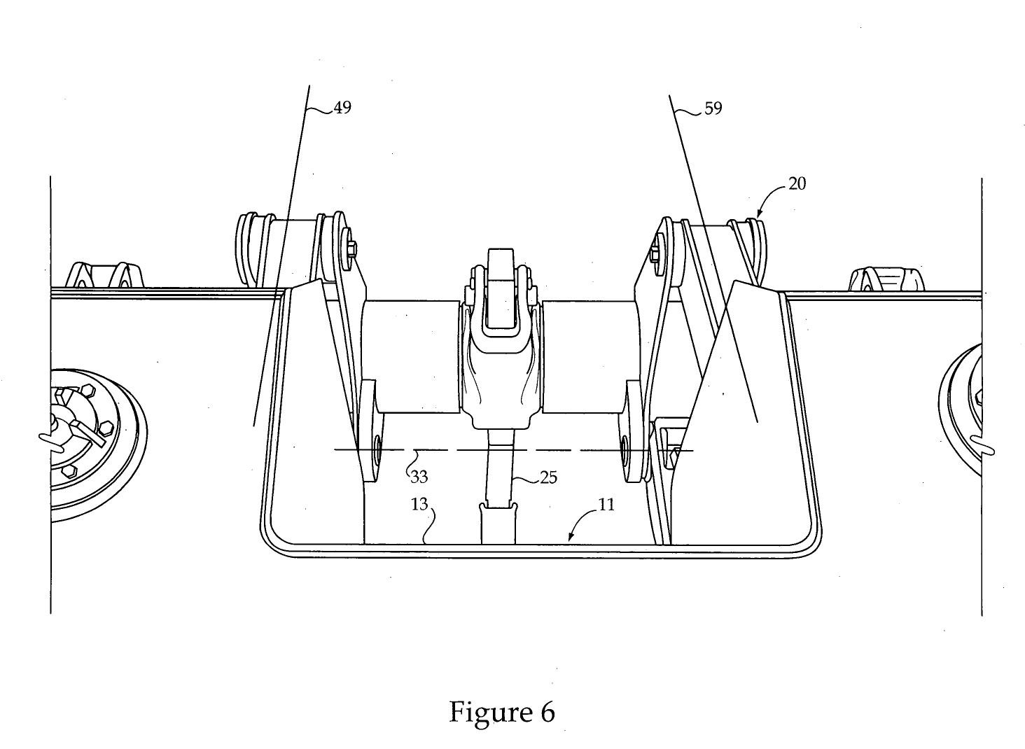

FIGS. 5 and 6 also shows a production ripping side view and a line of sight view within cone 90 from the operator station 12 of track type tractor 11 when ripper assembly 20 is in the dig position with ripper tip 26 at maximum ground penetration. As can be seen, a portion of the ripper shank 25 above ground penetration level 16 remains visible and is unobstructed by the ripper assembly from the operator station 12. This allows the operator to have a direct view, unobstructed by the ripper assembly, for visual feedback during production ripping operations. At both the penetration and dig positions, the line of sight from the operator station 12 to the central ripper shank 25 extends between the left linkage 40 and right linkage 50.

### INDUSTRIAL APPLICABILITY

The present disclosure find potential application to any ripper assembly, especially those associated with multi-shank rippers as an optional accessory for a track type tractor. Although the present disclosure is illustrated in the context of a so called fixed parallelogram design, the present disclosure is not so limited. In particular, the present disclosure could find potential application to variable parallelogram designs and other shapes that otherwise include a linkage assembly and a beam assembly that carries one or more ripper shanks. The present disclosure finds particular application to medium class track type tractors, such as tractors in the comparable range to a Caterpillar D6 track type tractor.

Track type tractors are used in various applications including, but not limited to, dozing and ripping. Typical dozing applications are performed with ripper assembly 20 stowed in its upward raised position as shown in FIG. 2. By having a ground clearance angle of about 30°, the ripper assembly of the present disclosure can usually be well out of the way of the ground and other possible interfering features of ground terrain when working in dozing applications, such as slot dozing or V-ditching. The ground clearance angle of about 30° usually prevent interference of the ripper shank 25 or tip 26 with the ground, trailer, or ramp during machine transportation, including loading and unloading. When engaging in ripping applications, the operator can view from the operator station 12 the central ripper shank 25 and tip 26 as the beam assembly 32 is lowered toward a dig position in response to a suitable control input from an operator. In the illustrated embodiment, the lowering operation is performed by extending hydraulic actuators 48 and 58. Because of the structure of the ripper assembly 20 and its attachment configuration to the back 13 of track type tractor 11, the operator can have a direct line of sight that is unobstructed by the ripper assembly from the operator station to the central ripper shank 25 and tip 26 as the tip passes through a ground penetration level 16 as shown in FIG. 4. This line of sight extends between the left linkage 40 and right linkage 50, which may be free of any potential obstructions by reducing or avoiding cross linkage between lower members 44 and 54. Thus, the operator can directly visually observe the initiation of production ripping when ripper tip 26 passes through ground penetration level 16. As the production ripping process continues, the beam assembly 32 is further lowered to its dig position. At this point, the operator maintains a direct line of sight that is unobstructed by the ripper assembly from the operator station 12 to the portion of the central ripper shank 25 that is above ground penetration level 16. Thus, as the production ripping process continues, the operator can periodically turn and have direct visual feedback of the ripping location from the operator station 12. These lines of sight that are unobstructed by the ripper assembly help serve to eliminate guess work on the part of the operator and may reduce or eliminate the need for auxiliary viewing equipment, such as remote cameras and the like. As the production ripping process continues, especially in the case of a multi-shank ripping job, the ripper assembly 20 can encounter side and twisting loads. By utilizing the structure described above, the beam assembly 32 is the primary absorber of side and twist loads that in the past were often absorbed via cross bracing between linkage members. When the operator reaches an end of a production ripper location job, the operator utilizes an appropriate control to move the ripper assembly from the dig position to its raised position.

By utilizing the structure for a ripper assembly according to the present disclosure, the overall weight of the ripper assembly 20 for a given class of machine may be greatly decreased. In fact, for an appropriately matched combination of ripper assembly 20 and track type tractor 11, the ratio of the ripper mass is less than about 6% of the tractor mass, when one utilizes the previously described structure. Thus, a ripper assembly according to the present disclosure can result in improved visibility and improved performance while reducing the overall weight of the machine 10. For one specific example, the ripper assembly 20 of the present disclosure 20 may increase penetration depth and penetration force may be increased by almost 10% over a previous design, and pry out force may be nearly doubled. Part of the penetration force improvement may be attributable to the fact that hydraulic actuators 48, 58 are extended, rather than contracted, when lowering beam assembly 32 toward a dig position. In addition, visibility may be greatly improved and overall weight decreased while improving the ability to move the ripper assembly 20 to a relatively high ground clearance angle of about 30°.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A ripper assembly comprising:
a beam assembly with a central ripper shank and tip flanked by a left linkage and a right linkage;
the left linkage including an upper member extending between the beam assembly and an upper left tractor mount, a lower member extending between the beam assembly and a lower left tractor mount, and a left hydraulic actuator extending between the beam assembly and the upper left tractor mount;
the right linkage including an upper member extending between the beam assembly and an upper right tractor mount, a lower member extending between the beam assembly and a lower right tractor mount, and a right hydraulic actuator extending between the beam assembly and the upper right tractor mount;
the left hydraulic actuator and the lower member of the left linkage being connected to the beam assembly via a left common pin; and
the right hydraulic actuator and the lower member of the right linkage being connected to the beam assembly via a right common pin.

2. The ripper assembly of claim 1 wherein the left linkage and the right linkage being unconnected to each other except via the beam assembly; and
the upper member of the left linkage and the upper member of the right linkage have fixed lengths.

3. The ripper assembly of claim 1 wherein the low member of the left linkage and the lower member of the right linkage have a combined lower linkage mass;
the beam assembly has a beam mass; and
the combined lower linkage mass is about 30% of the beam mass.

4. The ripper assembly of claim 3 wherein the beam assembly includes an elongate hollow cylinder with a circular cross section.

5. The ripper assembly of claim 4 wherein the central ripper shank is mountable to the beam assembly at one of a shallow rip configuration and a deep rip configuration.

6. The ripper assembly of claim 5 wherein the beam assembly includes a left shank mount outboard from the left linkage, and a right shank mount outboard from the right linkage.

7. The ripper assembly of claim 6 wherein the left linkage and the right linkage being unconnected to each other except via the beam assembly; and
the upper member of the left linkage and the upper member of the right linkage have fixed non-extendable lengths.

8. A machine comprising:
a track type tractor that includes an operator station;
a ripper assembly attached to a back of the track type tractor, and including a beam assembly with a central ripper shank and a central ripper tip flanked by a left linkage and a right linkage, and at least one hydraulic actuator for moving the beam assembly between a raised position and a dig position;
each of the left linkage and the right linkage including an upper member and a lower member extending between the beam assembly and the track type tractor;
an initial penetration view of the central ripper tip being unobstructed from the operator station when the beam assembly is between the raised position and the dig position, and the central ripper tip is at a ground penetration level; and
a production ripping view of a portion of the central ripper shank above the ground penetration level being unobstructed from the operator station when the beam assembly is at the dig position.

9. The machine of claim 8 wherein the at least one hydraulic actuator includes the left linkage having a left hydraulic actuator, and the right linkage having a right hydraulic actuator;
the left hydraulic actuator extending between an upper left tractor mount and a lower left beam mount; and
the right hydraulic actuator extending between an upper right tractor mount and a lower right beam mount.

10. The machine of claim 9 wherein the upper member, the lower member and the left hydraulic actuator of the left linkage are intersected by a left plane perpendicular to an axis of the beam assembly; and
the upper member, the lower member and the right hydraulic actuator of the right linkage are intersected by a right plane that is parallel to the left plane.

11. The machine of claim 10 wherein the left linkage and the right linkage are free of cross bracing therebetween except for cross bracing provided by the beam assembly.

12. The machine of claim 11 wherein the central ripper shank is mountable to the beam assembly at one of a shallow rip configuration and a deep rip configuration;
the beam assembly includes a plurality of shank mounts; and
the upper member of the left linkage and the upper member of the right linkage have fixed non-extendable lengths.

13. The machine of claim 8 wherein the ripper assembly has a ripper mass;
the track type tractor has a tractor mass; and
the ripper mass is less than about 6% of the tractor mass.

14. The machine of claim 8 wherein the ripper assembly has ground clearance ramp angle of about 30 degrees when the beam assembly is at the raised position.

15. The machine of claim 8 wherein the at least one hydraulic actuator includes the left linkage having a left hydraulic actuator, and the right linkage having a right hydraulic actuator;
the left hydraulic actuator and the lower member of the left linkage are connected to the beam assembly via a left common pin; and
the right hydraulic actuator and the lower member of the right linkage are connected to the beam assembly via a right common pin.

16. The machine of claim 15 wherein the ripper assembly has a ripper mass;
the track type tractor has a tractor mass; and
the ripper mass is less than about 6% of the tractor mass.

17. The machine of claim 16 wherein the at least one hydraulic actuator includes the left linkage having a left hydraulic actuator, and the right linkage having a right hydraulic actuator;
the left hydraulic actuator extending between an upper left tractor mount and a lower left beam mount;
the right hydraulic actuator extending between an upper right tractor mount and a lower right beam mount;
the upper member, the lower member and the left hydraulic actuator of the left linkage are intersected by a left plane perpendicular to an axis of the beam assembly;
the upper member, the lower member and the right hydraulic actuator of the right linkage are intersected by a right plane that is parallel to the left plane;
the central ripper shank is mountable to the beam assembly at one of a shallow rip configuration and a deep rip configuration;
the beam assembly includes a plurality of shank mounts; and
the ripper assembly has ground clearance ramp angle of about 30 degrees when the beam assembly is at the raised position.

18. A method of ripping, comprising the steps of:
moving a beam assembly of a ripper assembly from a raised position toward a dig position;
observing a central ripper tip along a line of sight extending from an operator station of a track type tractor to the central ripper tip when the central ripper tip is at a ground penetration level, where the line of sight extends between a left linkage and a right linkage of the ripper assembly; and
observing a portion of a central ripper shank above the ground penetration level along a line of sight from the operator station to the central ripper shank when the beam assembly is at the dig position, where the line of sight extends between the left linkage and the right linkage of the ripper assembly.

19. The method of claim 18 including absorbing side loads and twist loads on the ripper assembly via the beam assembly without cross bracing between the left linkage and the right linkage.

20. The method of claim 18 wherein the moving step includes extending a right hydraulic actuator and a left hydraulic actuator; and
raising the ripper assembly to a ground clearance ramp angle of about 30 degrees at the raised position.
